(19) United States
(12) Patent Application Publication
(10) Pub. No.: US 2006/0169044 A1
(43) Pub. Date: Aug. 3, 2006

(54) Mems accelerometers

(75) Inventors: Diana Hodgins, Codicote (GB); Joseph Mark Hatt, Hertfordshire (GB)

Correspondence Address: Rodney L Skoglund;RENNER KENNER GRIEVE BOBAK TAYLOR & WEBER, Fourth Floor, First National Tower, Akron, OH, 44308-1456, US

(73) Assignee: EUROPEAN TECHNOLOGY FOR BUSINESS LIMITED, Codicote (GB)

(21) Appl. No.: 10/549,337

(22) PCT Filed: Mar. 11, 2004
(86) PCT No.: PCT/GB04/01036

§ 371 Date: Sep. 13, 2005

(30) Foreign Application Priority Data
Mar. 14, 2003 (GB) 0305857.5

(51) Int. Cl. G01P 15/09

(52) U.S. Cl. 73/514.34; 73/514.36

(57) ABSTRACT

A micro-electro-mechanical systems (MEMS) accelerometer comprises a wafer micro-fabricated to provide a frame (10) defining an opening within which is disposed a sensing mass (14). A pair of aligned pivot beams (15) connect the mass to the frame (10) so that the axis of pivoting is displaced from the centre of gravity of the mass. At least one sensing beam (16) connects the mass (14) to the frame, the sensing beam (16) being distorted by pivoting movement of the mass (14). Distortion of the sensing beam on pivoting movement of the mass is determined, from which the acceleration of the accelerometer may be determined.

This invention relates to a micro-electro-mechanical systems (MEMS) accelerometer.

There is a demand for low weight and low cost accelerometers, accurately to measure both amplitude and direction of acceleration, in three dimensions. Many macro-scale devices have been designed, usually consisting of an assembly of three single axis accelerometers, arranged with their sensing axes orthogonal to each other. Such a macro accelerometer typically comprises an assembly of multiple components and consequently the resultant three-axis accelerometer often is significantly larger than can be accommodated for the intended purpose. Further, the overall assembly may be heavier than is desired for the intended use.

Micro-electro-mechanical systems (MEMS) technologies have enabled the manufacture of conventional mechanical devices but on a micro-scale, using manufacturing procedures developed from the manufacture of LSI semi-conductor electronic components on a single wafer, for example of silicon. MEMS technologies have led to the production of low weight and low cost three axis accelerometers. These are being employed widely in various industries and have the advantage of being relatively small and light-weight, as compared to macro devices, and yet are capable of giving extremely accurate and reliable indications of acceleration in three dimensions.

A common principle of a MEMS single axis accelerometer is to support a proof mass on a frame, by means of one or more resiliently-deformable beams. When an acceleration is applied to the frame, the or each beam is deformed out of its at-rest state by the force required to accelerate the proof mass, and so the proof mass moves relative to the frame. The motion of the proof mass is controlled by the elastic nature of the beams, which apply a restoring force to return the proof mass to its rest position. Acceleration can be measured by sensing the strain in the or each beam that supports the proof mass, typically using either piezo-electric or piezo-resistive sensors associated with the or each beam.

An alternative design of MEMS accelerometer again uses a proof mass supported by one or more resiliently-deformable beams, the mass carrying one plate of a capacitor and the frame carrying the other plate. Acceleration is sensed by measuring the change in capacitance due to the relative movement of the two plates. Yet another known form of MEMS accelerometer uses a torsion member to constrain a proof mass and a capacitive or servo-capacitive arrangement is used to measure the displacement of the mass when the accelerometer is subjected to acceleration. The torsional stiffness of the support member controls the displacement of the proof mass, or electrostatic forces generated by the servo-capacitors control that displacement.

Broadly, there are three types of MEMS accelerometers able to determine acceleration in three orthogonal axes. These are:

1. Three separate single-axis MEMS accelerometers are mounted on to three faces of a cube, to measure acceleration in three directions. The whole assembly of the individual wafers and the mounting cube significantly increases the weight of the complete 3-axis accelerometer. Further, difficulties in aligning the three accelerometers with great accuracy incurs significant manufacturing difficulties and so there is a cost penalty.

2. A MEMS accelerometer with a single mass is used to sense acceleration in three orthogonal directions. Ideally the sensitivities in each direction would be equal but in practice the out-of-plane response (with respect to the wafer) is usually several times larger than the in-plane response. Isolation of the individual signals for each direction is limited by the accuracy of manufacture of the device and the requirement for equal signals from each axis, leading to cross-axis signals. The performance of such a device is consequently compromised.

3. Multiple single axis MEMS devices are produced in a single wafer, to sense acceleration in three directions. Using MEMS technology, three or more identical devices can be produced in a single wafer, but this gives un-equal responses in the out-of-plane direction as compared to the in-plane directions.

Due to the nature of micro-fabrication techniques, the required features to be constructed in a wafer are essentially patterned in two dimensions, but a number of layers of varying thickness can be created on top of each other. Such a micro-fabricated wafer is often referred to as a 2½D structure, where the pattern is essentially the same through the thickness of the wafer or is defined by the crystal orientation and etching process.

A typical three axis accelerometer manufactured using MEMS technology from a single wafer cannot produce exactly the same strain distribution in the support beams for the proof mass in response to in-plane and out-of-plane accelerations. Inevitably, having regard to the manufacturing processes, the support beams are in the plane of the wafer and so the strain sensing for in-plane and out-of-plane accelerations require different strain sensing mechanisms.

The present invention aims at improving on known designs of MEMS accelerometer, to minimize the response in the out-of-plane direction. As such, a further aim of an embodiment of this invention is to provide a multiple axis accelerometer where at least two single axis accelerometers are fabricated using MEMS technology in a single wafer.

According to one aspect of the present invention, there is provided a micro-electro-mechanical systems (MEMS) accelerometer comprising: a wafer micro-fabricated to provide frame defining an opening; a sensing mass disposed within the opening of the frame and connected to the frame by a pair of aligned pivot beams disposed so that the axis of pivoting of the mass with respect to the frame is displaced from the centre of gravity of the mass; and at least one sensing beam connecting the mass to the frame and arranged such that pivoting movement of the mass will distort the sensing beam, whereby pivoting movement of the mass may be detected by sensing the distortion of the sensing beam.

With the accelerometer of this invention, the proof mass is constrained to perform a pivoting motion with respect to the frame when subjected to an in-plane acceleration, the motion of the mass being controlled by the or each sensing beams, if more than one such beam is provided. Acceleration in the direction of the pivotal axis will produce essentially no movement of the mass. Further, acceleration in a direction through both the pivotal axis and the centre of gravity of the mass equally will produce minimal movement of the mass. As such, the accelerometer can be regarded as a true single-axis accelerometer giving very small cross-axis errors.

Most preferably, there are two sensing beams disposed symmetrically with respect to the frame and the mass, the beams connecting opposed locations of the mass to the frame and arranged such that pivoting movement of the mass will flex both sensing beams, but in opposite senses. Thus, the sensing beams may extend substantially co-lineally, from opposed sides of the mass to the frame

The MEMS manufacturing technique used to produce the accelerometer of this invention preferably provides the frame, mass, pivoting and sensing beams all from a single wafer of semi-conductor material, using known etching techniques. Suitable treatment of the wafer may confer piezo-electric or piezo-resistive properties on the or each sensing beam, whereby the flexing thereof may be detected by determining a change in the electrical characteristics of the or each beam. In the alternative, the or each sensing beam may include implanted or deposited metallic components whereby the flexing of the or each beam may be detected by determining a change in the electrical characteristics of those components.

Advantageously for MEMS manufacturing techniques, the mass may have the general shape of a cuboid and the sensing beams extend from two opposed edges of a face of the mass to the frame. Further, the pivot beams may be disposed substantially centrally of the face of the mass from which the sensing beams extend, the pivot axis extending transversely across that face. Again, using MEMS fabrication techniques, the pivot axis of the pivot beans should be at or closely adjacent to said face of the mass.

Two accelerometers of this invention may be provided in a single wafer. In this case, the MEMS fabrication technique may provide two openings in the wafer, in each of which openings is provided a similar mass, mounted in the respective opening by an associated pair of pivot beams and an associated pair of sensing beams, but with the pairs of pivot beams of the two accelerometers at right angles to each other. Thus, such an accelerometer will sense acceleration in two orthogonal directions.

Further, the frame may define a third opening and a third mass is disposed within that third opening, the principal sensing axis of the third mass being out-of-plane of the wafer and so substantially orthogonal to the sensing axes of the first and second masses. For such an arrangement, the third mass may be supported on one or more sensing beams. For example, there may be four sensing beams extending in two directions orthogonal to each other and in the plane of the frame, but such an accelerometer will be sensitive to a small extent to accelerations in-plane. That may be eliminated by appropriate processing of the signals from all four sensing beams.

By way of example only, one specific embodiment of MEMS three-axis accelerometer of this invention will now be described in detail, reference being made to the accompanying drawings, in which:—

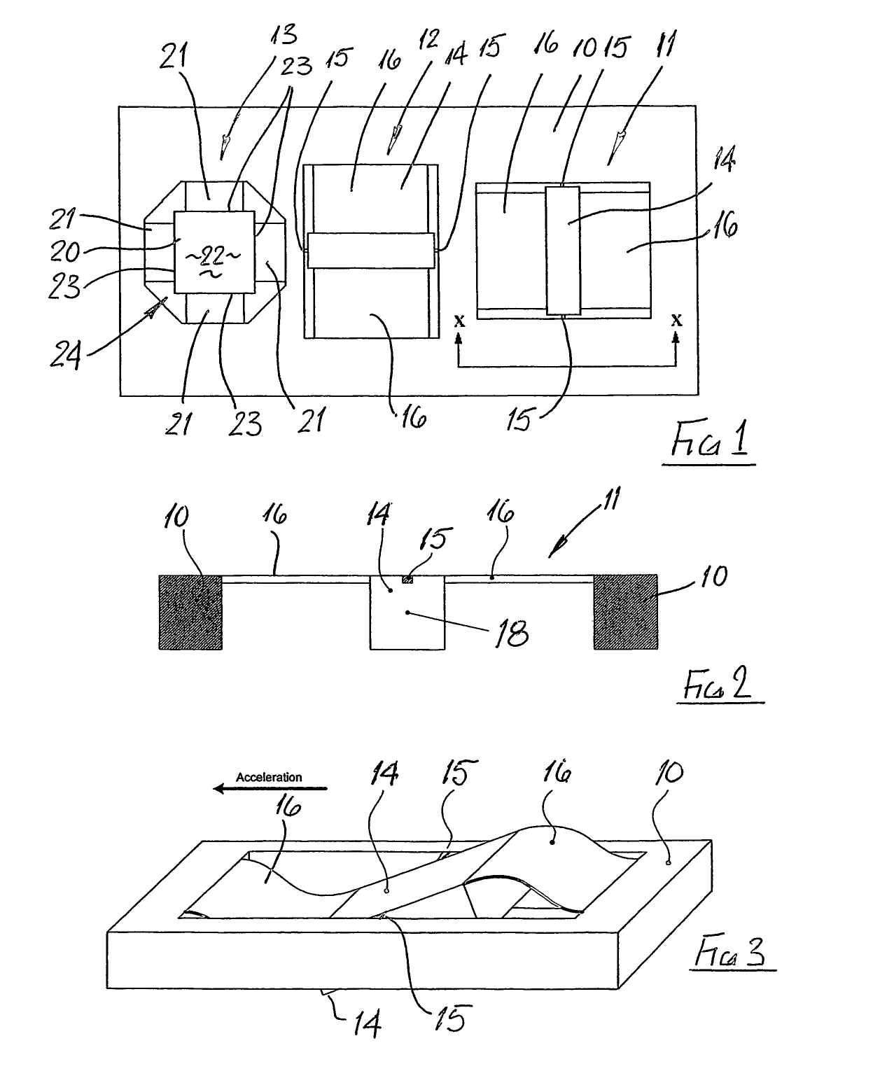

FIG. 1 is a plan view of the embodiment of single wafer accelerometer;

FIG. 2 is a diagrammatic cut-away view through one of the three single axes accelerometers of the assembly of FIG. 1 taken on line X-X marked on that Figure; and

FIG. 3 illustrates the operation of one of the single axis accelerometers of the embodiment of FIG. 1 when subjected to an in-plane acceleration.

The embodiment of accelerometer shown in the drawings is intended accurately to measure both amplitude and direction of acceleration, in three orthogonal axes. Micro-fabrication techniques are used to manufacture three individual single-axis accelerometers on a common silicon wafer. The required alignment accuracy can be achieved using lithographic etching processes, derived from the electronics industry, and no subsequent assembly processes are required to complete the basic structure of the three-axis accelerometer. The sensing of acceleration is by piezo-electric or piezo-resistive measurement of strain in the support beams for each of the three masses, for each accelerometer, respectively.

FIG. 1 is a plan view on the embodiment of accelerometer of this invention. A single silicon wafer 10 is processed by conventional lithographic and etching techniques to provide a frame defining three openings in which are formed respective first, second and third individual accelerometers. The first accelerometer 11 is a single axis design intended to sense acceleration in the X-axis (that is, along the length of the silicon wafer 10), the second accelerometer 12 is similar to the first accelerometer 11 but is intended to sense acceleration in the Y-axis (that is, transversely to the length of the wafer 10), and the third accelerometer 13 is of a conventional design and is intended primarily to sense acceleration in the Z axis (that is, normal to the surface of the wafer 10). Having regard to the construction of the third accelerometer, it will also measure acceleration in the plane of the wafer but the response in that plane will be very much less than in the Z-axis.

Each of the first and second accelerometers 10 and 11 comprises a proof mass 14 etched from the material of the wafer 10 but still connected thereto by an aligned pair of pivot beams 15 and also by a pair of sensing beams 16, which beams 15 and 16 also are etched from the material of the wafer 10. The upper surfaces of the pivot beams 15, the sensing beams 16 and the upper surface of the proof mass 14 all lie in the common plane of the upper surface of the wafer 10 and thus the centre of gravity 18 of the proof mass is displaced from the pivot beams 15. In this way, the pivot beams 15 constrain movement of the proof mass to be generally a rotary motion about the axis of the pivot beams 15 when the accelerometer is subjected to acceleration in the plane of the wafer and normal to the common axis of the pivot beams 15. This rotary motion causes the sensing beams 16 to flex in opposite senses, as shown on an exaggerated scale in FIG. 3.

The first and second accelerometers 11 and 12 are essentially of the same construction except that the pivotal axes of the respective pivot beams 15 are at right-angles to each other. The third accelerometer 13 is different in that it has a proof mass 20 of generally cuboidal form which is supported by four sensing beams 21, one beam extending from each edge 23 respectively of the upper surface 22 of the proof mass 20, to the adjacent edge of the opening 24 in the wafer 10. Each sensing beam 21 is treated in a similar manner to the sensing beams 16 of the first and second accelerometers, whereby the electrical characteristics of the beams depend upon the flexing thereof, when the proof mass 20 is subjected to acceleration. This third accelerometer 13 is thus an essentially conventional MEMS design.

Acceleration in the Z-axis will move the proof mass 20 in a direction normal to the surface of the wafer 10, depending upon the sense of the acceleration. This will uniformly deflect all four sensing beams 21 and the magnitude of the acceleration can be determined from the strain in those beams. Acceleration in the plane of the wafer will also apply a force to the proof mass 20 tending to move the mass but in view of the width of the sensing beams 21, those beams are very stiff to deflection in the in-plane direction and so there will be only very small strains in the beams 21.

The magnitude of the acceleration can be determined by treating or depositing material on the sensor beams 16 and 21 so as to have a piezo-electric or piezo-resistive properties, and then monitoring the beams for changes in the electrical characteristics. For the first and second accelerometers 11 and 12, the mechanical deformation of the sensing beams 16 in response to acceleration in the plane of the wafer and normal to the respective pivot axis will give the greatest response in terms of both sensing beam deformation and so sensing signal as well. The mechanical deformation of the sensing beams in response to acceleration in other directions is greatly reduced by the effect of the pivot beams. Without the pivot beams, acceleration in the measuring direction may generate a lower strain than for acceleration in either of the other two directions.

Theoretically, for an arrangement without pivot beams, the response in a non-measured axis can be cancelled out by appropriate configuration of the strain measuring mechanism. However, any misalignment introduced by manufacturing tolerances, on a micro-metre scale, can produce a significant cross-axis error. The provision of the pivot beams 15 minimizes the cross-axis signal by reducing the signal strength at source. For example, without pivot beams a two-micron positional misalignment may cause a 0.60% cross-axis error, but by providing pivot beams as described above, this can be reduced to 0.03%.

The pivot beams enable the X- and Y-axis accelerometers 11 and 12 to have lower sensing beam stiffnesses for a given first resonant frequency of the assembly. The first resonant frequency is normally a limiting factor when designing an in-plane sensor since the lowest resonant frequency defines the bandwidth of the device. As an example, the maximum in-plane signal strength for a conventional design of MEMS accelerometer may be 2 units compared to the out-of-plane signal strength for the same device at 5 units. The first resonant frequency may be at 5 kHz in the out-of-plane mode and at 7 kHz in the in-plane mode. By contrast, a device of essentially the same size but arranged as in the present embodiment may produce an in-plane signal of 5 units and an out-of-plane signal of 0.2 units. The first resonant frequency will be 5 kHz in the sensitive in-plane mode and the second resonant frequency at 18 kHz in the out-of-plane mode. If the pivot beams are then removed, it can be shown that the out-of-plane resonant frequency falls to 2 kHz and the out-of-plane signal strength increases to 20 units.

A typical MEMS fabrication technique for the embodiment of accelerometer as described above is to create the beams and proof masses from a single <100> orientation silicon wafer of 500 microns thick. The beams are patterned by etching from the top side of the wafer and the proof masses are separated from the frame by etching through the bulk of the wafer from the opposite side. The beam thickness is defined by an etch-stop process. This may include the use of an oxide layer in an SOI wafer, doping the top surface of a conventional silicon wafer, or simply timing the etch. Etching can be by wet or dry methods (such as KOH or DRIE), depending upon the desired final shape of the accelerometer.

The deformation of the support beams can be measured by creating piezo-resistive tracks to act as strain gauges for the beams, or by depositing film-type piezo-electric sensors on the surface of the beams during the fabrication of the device. Suitable conductors are then electrically connected to the ends of the tracks, to permit measurement of the deformation of the strain gauges. Other techniques may be employed for measuring the strain of the beams when the device is subjected to acceleration.

1. A micro-electro-mechanical systems (MEMS) accelerometer comprising a wafer micro-fabricated to provide frame defining an opening, a sensing mass disposed within the opening of the frame, a pair of aligned pivot beams formed integrally with the frame and mass from the wafer and defining a pivot axis for the mass, the pivot beams being disposed so that pivoting of the mass with respect to the frame about said pivot axis is displaced from the center of gravity of the mass, and at least one sensing beam connecting the mass to the frame and arranged such that pivoting movement of the mass about said pivot axis will distort the sensing beam, whereby pivoting movement of the mass may be detected by sensing the distortion of the sensing beam.

2. A MEMS accelerometer as claimed in claim 1, wherein the mass is connected to the frame by two sensing beams extending from opposed sides of the mass to the frame whereby the sensing beams are distorted in opposite senses upon the mass performing pivoting movement.

3. A MEMS accelerometer as claimed in claim 1, wherein the frame, the mass, the pivoting beams and the at least one sensing beam are all produced from a single wafer of semiconductor material by micro-electro-mechanical systems techniques.

4. A MEMS accelerometer as claimed in claim 3, wherein the at least one sensing beam is of a piezo-electric material whereby the distortion of the at least one sensing beam may be detected by determining a change in the electrical characteristics of the piezo-electric material.

5. A MEMS accelerometer as claimed in claim 1, wherein the at least one sensing beam includes implanted or deposited metallic components whereby the distortion of the at least one beam may be detected by determining a change in the electrical characteristics thereof.

6. A MEMS accelerometer as claimed in claim 2, wherein the sensing beams are co-axial and extend substantially co-linearly in opposite directions away from opposed sides of the mass to the frame.

7. A MEMS accelerometer as claimed in claim 1, wherein the mass has the general shape of a cuboid and the sensing beams extend from a face thereof to the frame.

8. A MEMS accelerometer as claimed in claim 7, wherein the pivot beams are disposed substantially centrally of the face from which the beams extend, said pivot axis extending transversely across that face.

9. A MEMS accelerometer as claimed in claim 8, wherein the pivot axis of the pivot beams lies in one of (1) within the plane of said face and (2) adjacent the plane of said face from which the at least one sensing beam extends.

10. A MEMS accelerometer as claimed in claim 7, wherein the at least one sensing beam has a substantially rectangular profile, in the plane of the face of the mass from which said sensing beam extends.

11. A MEMS accelerometer as claimed in claim 1, wherein the at least one sensing beam and the pivot beams are substantially co-planar when the accelerometer is at rest.

12. A MEMS accelerometer as claimed in claim 1, wherein the frame defines two openings in each of which is provided a similar mass, mounted in the opening by a respective pair of pivot beams and at least one respective sensing beam.

13. A MEMS accelerometer as claimed in claim 12, wherein the sensing beams of the two masses are substantially co-planar but the respective pairs of pivot beams are substantially orthogonal, whereby the two masses sense acceleration in orthogonal directions.

14. A MEMS accelerometer as claimed in claim 12, wherein the frame defines a third opening and a third mass is disposed within the third opening, the sensing axis of the third mass being substantially orthogonal to the sensing axes of the first and second masses.

15. A MEMS accelerometer as claimed in claim 14, wherein the third mass is supported on one or more sensing beams.

16. A MEMS accelerometer as claimed in claim 15, wherein the third mass is supported by four sensing beams extending in two directions orthogonal to each other.

17. A MEMS accelerometer as claimed in claim 16, wherein the third mass has the general shape of a cuboid and the four sensing beams extend respectively from each of the four edges of a face of the third mass to the frame.

18. A MEMS accelerometer as claimed in claim 17, wherein the four sensing beams associated with the third mass are substantially co-planar with the sensing beams of the other two masses.

19. A MEMS accelerometer as claimed in claim 4, wherein the at least one sensing beam carries piezo-electric material whereby the distortion of the at least one sensing beam may be detected by determining a change in the electrical characteristics of the piezo-electric material.
